(19) United States
(12) Patent Application Publication
(10) Pub. No.: US 2008/0060980 A1
(43) Pub. Date: Mar. 13, 2008

(54) MAIL SORTING MACHINE EXPANSION WITH DIRECTION-REVERSING ELEVATING CONVEYOR

(76) Inventors: Lance W. Inman, Cushing, OK (US); Douglas J. Delperdang, Claremore, OK (US)

Correspondence Address: Stolowitz Ford Cowger LLP, 621 SW Morrison St, Suite 600, Portland, OR, 97205, US

(21) Appl. No.: 11/759,718

(22) Filed: Jun. 7, 2007

Related U.S. Application Data
(60) Provisional application No. 60/804,276, filed on Jun. 8, 2006.

(51) Int. Cl. B07C 5/00

(52) U.S. Cl. 209/509

(57) ABSTRACT

A system and method for sorting flat articles includes a first tier of a plurality of sorting stations, a second tier of plurality of sorting stations disposed generally over the first tier; a first tier transport section typically including a plurality of conveyor belts and rollers with the conveyor belts transporting flat articles along the first tier and routing the flat articles to the sorting stations of the first tier; a second tier transport section typically including a plurality of conveyor belts and rollers with the conveyor belts transporting the flat articles along the second tier and routing the flat articles to the sorting stations of the second tier, the second tier transport section being disposed generally above the first tier transport section; and an elevating transport section including a plurality of conveyor belts and rollers, the elevating transport section connecting an exit end of the first tier transport section to an input end of the second tier transport section.

### RELATED APPLICATION DATA

This application claims priority to provisional application No. 60/804,276 filed Jun. 8, 2006 hereby incorporated by reference.

### BACKGROUND

The field of this application relates to flat article sorting methods and machines such as, for example, automated mail handling equipment.

Several different mail sorting machines are presently in use by various commercial and government entities. These machines typically operate by processing mail pieces by optical character recognition (OCR) scanning and bar coding, then sorting the recognized mail pieces into various individual pockets or bins.

Many mail sorting machines presently installed and in operation include a single row of sorting stations with pockets or bins that are only one level (tier) high. The pockets or bins may be located on one or both sides of a main linear transport path defined by pairs of conveyor/drive belts circulating along horizontal paths. The transport path holds mail pieces on edge, in a generally vertical orientation between adjacent pairs of conveyor belts. Computer-controlled diverter gates located at each sorting station are triggered to divert mail pieces from the main transport path into the appropriate pocket or bin. Examples of such systems include the J-Series sorters sold by Böwe Bell+Howell of Raleigh, N.C., as well as systems sold by OPEX Postal Technologies of Irving, Tex.

Many entities require a large number of pockets (100 pockets or more) and so these machines can require a great deal of floor space, often exceeding 80 feet long. As business needs develop and grow, more pockets may be required. Previously, there have been two known solutions to increase the number of sorting stations and pockets, to meet business needs:
Adding similar pocket sections to the end of the sorting line, further increasing the length of the machine. This solution requires the purchase of the sorting components plus the associated support structure. It also requires additional floor space which may cause the entity the additional expense of either increasing building size or procuring a larger building. Some systems are expandable with horizontal turn sections that direct the transport path to wind back and forth along the floor in a serpentine manner, with multiple rows of sorting stations. However, in such systems, it is necessary to leave access aisles between the rows, further increasing floor space requirements.
Replacing the existing system with an entirely new system having multi-tier column of pocket sections that increase capacity by providing a column of two or more levels of pockets using the same floor space. Such systems include diverter gates at the input end of the column to direct mail pieces up the column to the appropriate pocket. These systems require replacement of the existing single level sorting components and associated support structure, as well as significant changes to the sorting system control software.

The present inventors have identified a need for a more cost-effective and compact solution for expansion of a sorting system.

### SUMMARY

The present invention is related to flat article sorting methods and machines. In a preferred application as described below, an existing sorting machine is modified with an additional tier of sorting stations above a first row of sorting stations. The sorting stations of the added tier are connected to the end of the existing sorting stations in series by a direction-reversing elevating conveyor. In the added tier, the transport mechanism moves mail pieces in the opposite direction of the first row of sorting stations. The expansion solution described herein may utilize sorting components and support structure of the existing sorting machine. The upper expansion tier may include a “mechanical reject pocket” at the terminal/downstream end of the expansion tier and located near an operator station at the input end of the existing machine.

Additional aspects and advantages will be apparent from the following detailed description of preferred embodiments, which proceeds with reference to the accompanying drawings.

### BRIEF DESCRIPTION OF THE DRAWINGS

FIG. 1 is a top plan view showing the terminal end of a bottom level of sorting stations including a transport path coupled to an input end of a direction-reversing elevating conveyor.

FIG. 2 is a top plan view showing further details of the direction-reversing elevating conveyor of FIG. 1 and its connection to an upper level of sorting stations stacked above the bottom level stations of FIG. 1.

FIG. 3 is photograph of the direction-reversing elevating conveyor of FIGS. 1 and 2 taken from the direction illustrated by arrow 3-3 in FIGS. 1 and 2.

### DETAILED DESCRIPTION

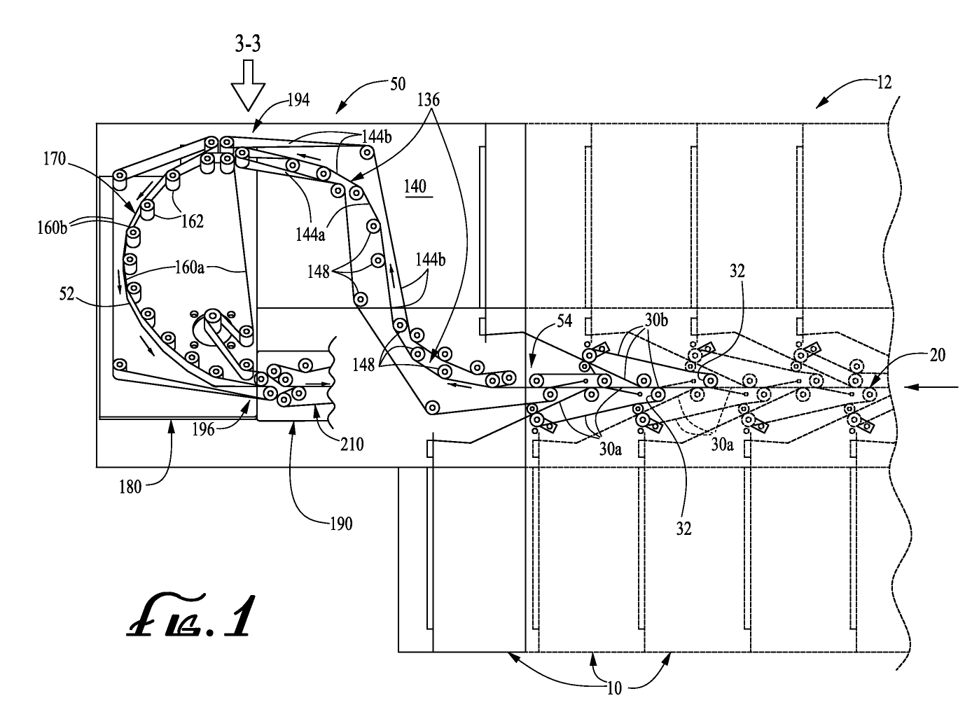

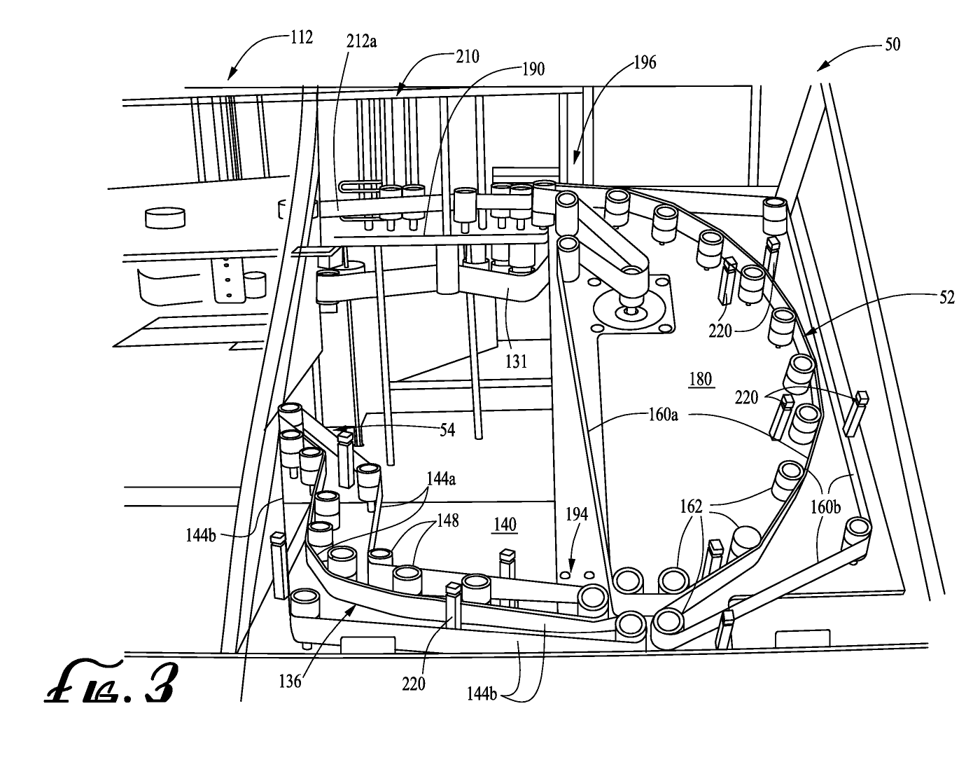

With reference to FIG. 1, existing sorting stations 10 of a lower level 12 (first tier) are positioned along a central transport path 20 formed by adjacent conveyor belts 30a, 30b and pulleys/rollers 32. Flat articles such as mail envelopes are transported in a vertical orientation along the path 20 between a pair of adjacent conveyor belts. The computer-controlled diverter gates located at each sorting station 10 are triggered to divert mail pieces from the transport path 20 into the appropriate pocket or bin. An elevator section 50 includes a direction-reversing elevating conveyor 52 appended to a terminal end 54 of the lower level 12. The elevator section 50 reverses the direction of the transport path and delivers mail items (not shown) to a row of sorting stations 110 of an upper level 112 shown in FIG. 3.

Each of the upper level sorting stations or “stacker sections” 110 is approximately four feet long. Stacker sections 110 may be manufactured as modular assemblies for ready installation at the customer's site. Vertical standoffs (not shown) are preferably added to the top of the customer's existing machine to provide the support structure for the upper level stacker sections 110.

The elevator section 50 may be manufactured as a unit and attached to the end of the existing single level machine using adapters. All other necessary power supplies, fuse blocks, terminal blocks, control processors (single-board computers), and any other electrical components may also be provided as a kit, together with the elevator section 50 and elevator adapters.

Power supplies, terminal blocks, fuse blocks, control processors and other electrical components of the sorting stations 110 of the upper level 112 may also be provided as a kit with each modular unit of sorting station. The power supplies, terminal blocks, control processors, fuse blocks and other necessary electrical components are either added within the framework of the existing lower level 12, or cabinets are added to house the additional electrical components required. Pass thru holes may be drilled in the existing lower level 12 of the machine for wiring as required. Electrical power may be supplied to the upper level 112 from the existing stations 10 of the lower level 12 by tapping into existing machine wiring. Larger circuit breakers and power supplies are added as needed, but no additional external power source is typically required.

The added upper level stacker sections 110 include all drive motors and other drive components required for conveyor belts 130a, 130b.

The end 54 of the existing lower level 12 is modified as needed to allow mail to pass through into the elevator section 50. Mail proceeds through the elevator section 50 first through a set of reverse curves 136 (FIG. 1) on a horizontal lower deck 140. The reverse curves 136 are defined by a set of flat belts 144a, 144b (which may include two or more belts) and pulleys/rollers 148.

The next portion of the elevator section 50 includes another set of flat belts 160a, 160b (again, including two or more belts) and pulleys 162. Belts 160a, 160b and pulleys 162 are arranged to define a curved reversing section 170 of the transport path 20 that extends along a canted plate 180, which is also referred to as the “slant deck”. The reversing section 170 reverses the direction of the mail pieces while the angle of the slant deck 180 provides the lift to “elevate” the mail pieces to the upper level 112.

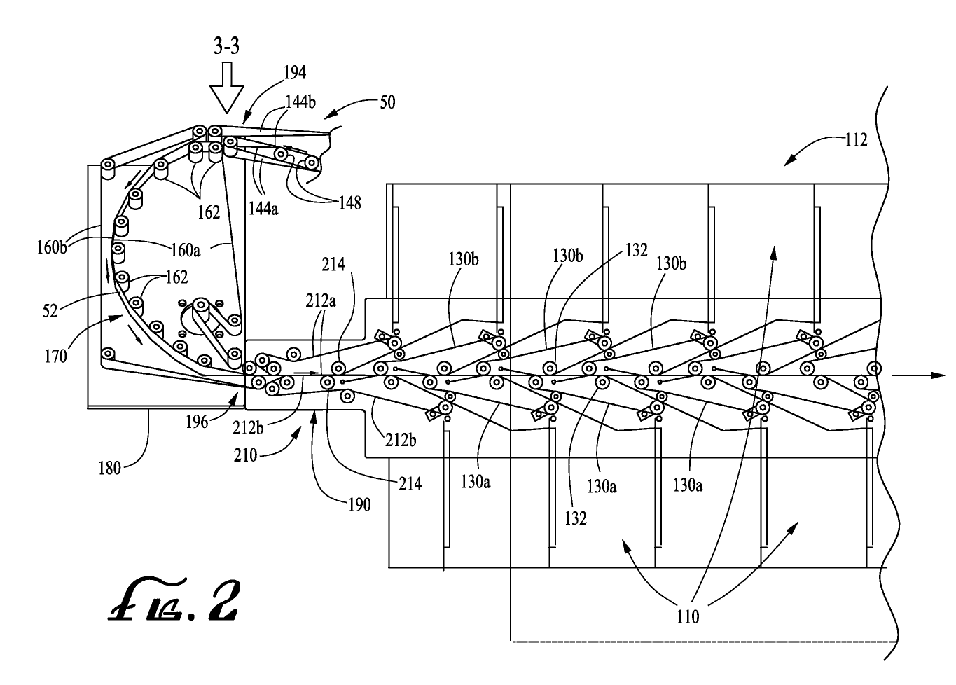

The last portion of the elevator section 50 is a horizontal upper deck 190 which is aligned to the same level as the stacker sections 110 of the upper level 112, thus enabling the mail pieces to continue through to the upper level stacker sections 110 and be sorted to the individual pockets as needed. In the embodiment shown in FIG. 3, an upper intake conveyor assembly 210 defines the section of the transport path along the upper deck 190 between the outlet of direction-reversing elevating conveyor 52 and the conveyor of upper stacker sections 110. Upper intake conveyor assembly 210 includes belts 212a and 212b (FIG. 2) and rollers 214 which are driven by drive system assembly 131 (FIG. 3). The drive system assembly 131 and drive components of the upper level 112 are preferably located above the lower level 12, which reduces the number of holes required through the support platform of the lower level 12 and eliminates problematic drive couplers used in other known multi-tiered designs.

At least some of the flat belts 160a, 160b, 144a, 144b of the elevator section 50 preferably overlap the regions where the canted plate 180 abuts the horizontal upper and lower decks 140, 190. Twists 194, 196 are induced in the belts at these overlapping regions to gradually twist the transport path for the mail pieces and facilitate a smooth transfer from the horizontal surface of the lower horizontal deck 140 to the slant deck 180 and back again to the horizontal surface of the upper deck 190.

Alternative designs may also be implemented for direction-reversing elevating conveyor 52. Following the teachings herein, one skilled in the art may be able to modify the design shown at FIGS. 7-20 and paragraphs [0100] to [0110] of U.S. Patent Application Publication No. 2002/0070149 A1 of Schererz et al., which is incorporated herein by reference. Schererz '149 also discloses a horizontal conveyor belt (106 in FIGS. 10 and 11 of Schererz '149) that may be used to facilitate transition from the horizontal portion of the transport path to the slanted transport path of the elevator.

Integration with Control Electronics

A sorting machine is normally controlled by sort software on a main control computer that communicates with a series of single board computers located at the sorting stations and elsewhere throughout the transport path.

Throughout the machine is a series of photocells or other optical sensors spaced at approximately twelve inch intervals. When these photocells are blocked by a mail piece, a signal is sent to a computer. These signals are used to track individual mail pieces, to sense jams, and to determine when to fire the diverter gates and other components which are used to place a mail piece into an individual pocket, in accordance with known methods.

The elevator section 50 and upper stacking stations 110 extend the existing control system by the placement of photocells and the addition of more single board computers as needed. Photocells 220 (including pairs of emitters and detectors) are shown distributed along the transport path of elevator section 50 in FIG. 3.

Computer communications that control run, jam, and bin destination functions in the upper level 112 are also derived from and integrated with the existing main control system. Preferably the elevator section 50 and upper level stacker sections 110 include single-board computers (not shown) that communicate with the existing single board computers of the lower sorting stations 10, which saves the customer the cost of replacing not only the existing single board computers, but also the sort software that operates on the main control computer.

Thus, the sorting system expansion described herein may be readily implemented as a retrofit to a customers' existing machine to save cost and minimize downtime.

By placing the elevator section 50 at the end of the existing lower level 12 of the machine, mail is sent to the upper level 112 by passive means—i.e. without requiring computer control to selectively direct only certain items of mail to the upper level, as in other multi-tiered systems. By default, if mail is not diverted into any of the lower level pockets 10, it will proceed to the elevator section 50 and then through to the upper level 112. Other multi-tiered solutions place their “elevator” section at the beginning of the stacker section. That arrangement requires diverter gates to send mail to the upper level(s). Those gates have a much higher usage than the common pocket gates and so require more frequent replacement.

A final pocket commonly known as a “Mechanical Reject Pocket” is normally provided on letter sorting machines. This pocket is the very last in the series of pockets and thus in the two-tier system of FIGS. 1-3, the mechanical reject pocket is located downstream of the upper level 112. Its function is to accumulate any mail pieces that were not diverted, usually due to some type of mechanical failure. Mail pieces collected at the mechanical reject pocket are normally re-run through the sorter machine to attempt to achieve a correct sort. On some machines, the reject pocket is located on the end of the machine furthest from the operator. In the expansion system described herein, because the elevator is on the end furthest from the operator and the transport path of the upper level 112 flows back toward the operator's location, the mechanical reject pocket is located closer to the operator than in previous systems.

By expanding from the end and on top of an existing machine, the system of the present disclosure limits disruptions to the existing equipment. By including the drive mechanisms with the added components, there are no major modifications required to the existing equipment. The expansion sections 110 or elevator section 50 could even be removed and the existing equipment could be restored to its original functional condition. The expansion can be installed onsite at a customer facility.

The expansion solution described herein increases the sorting capacity of an existing sorting system by up to two times without a significant increase in required floor space—the only additional floor space needed is for the elevating section 50. The expansion solution described herein also avoids incurring the expense of replacing existing usable sorting components, support structure, and control systems, thereby leveraging return on the original investment in equipment.

It is probable that an existing single tier system is disposed at ground level and the second tier expansion would comprise placing the expansion second tier transport section generally above the first tier transport section. In such an arrangement, the elevating transport section connecting an exit end of the first tier transport section to an input end of the second tier transport section would transport items exiting the first tier transport section up to the entrance of the second tier transport section. In an alternate construction, the first tier may comprise the upper section disposed over the second tier and the elevating transport section connecting the exit end of the first tier transport section to the input end of the second tier transport section would transport items exiting the first tier transport section down to the entrance of the second tier transport section.

Since the elevating transport section and the second tier transport section only needs to operate once an article destined for a second tier sorting station passes out of the first tier sorting section, drive motor operation of the elevating transport section and/or second tier sorting section may be selectively shut down to conserve energy and system wear. Moreover, second tier sorting stations may be selected for less frequent sorting destinations to enhance shutdown times.

Various methods may be implemented via the described systems. A preferred method of sorting flat articles such as envelopes in a mail distribution system may include the steps of: arranging a first stage transport section 12 generally parallel with and in a stacked relationship with a second stage transport section 112 such that one of the stages is positioned above the other, each stage having a plurality of sorting stations 10, 110; establishing a transport path (a) through the first stage transport section 12 and to an exit 54 thereof, (b) from the exit 54 of the first stage transport section 12 to an inlet of the second stage transport section 112, (c) through the second stage transport section 112; and depositing an article in a desired pocket of a sorting station from one of the first stage and the second stage. The step of depositing an article in a desired pocket of a sorting station may include electronically reading information from the article; determining the desired pocket for the article depending on the information read; transporting the article along the transport path; and controlling operation of the sorting station corresponding to the desired pocket to divert the article from the transport path as it reaches that sorting station and to deposit the article in the desired pocket.

As described above, the systems and methods described may be particularly useful for expansion of an existing sorting system. One such method of expanding an existing sorting system comprised of a transport section 12 including a plurality of conveyor belts 30a, 30b and rollers 32, the conveyor belts 30a, 30b transporting flat articles along the transport section 12 and routing the flat articles to the sorting stations 10, includes the steps of: modifying a downstream end 54 of the existing transport section 12 to allow exit of flat articles therefrom; installing a second tier transport section 112 generally over the existing transport section 12, the second tier transport section 112 including a plurality of sorting stations 110, conveyor belts 130a, 130b and rollers 132, the conveyor belts 130a, 130b transporting the flat articles along the second tier transport section 112 and routing the flat articles to the sorting stations 110 of the second tier transport section 112; installing an elevating transport section 50 connecting an exit end 54 of the existing tier transport section 12 to an input end of the second tier transport section 112, the elevating transport section 50 comprising a plurality of conveyor belts 144a, 144b, 160a, 160b, 212a, 212b and rollers 148, 162, 214 for transporting flat articles from the existing transporting section 12 up to the second tier transport section 112. The method may further include one or more of the following: (a) using existing computer system and software for controlling operation of the second tier transport section 112; (b) transporting the flat articles through the second tier transport section 112 in a direction parallel and opposite to the direction of flat articles being transported through the existing transport system 12; and (c) transporting the flat articles on edge, in a vertical orientation between an adjacent pair of conveyor belts.

It will be obvious to those having skill in the art that many changes may be made to the details of the above-described embodiments without departing from the underlying principles of the invention.

1. A system for sorting flat articles comprising
a first tier of a plurality of sorting stations;
a second tier of plurality of sorting stations disposed generally over the first tier;
a first tier transport section including a plurality of conveyor belts and rollers, the conveyor belts adapted to transport flat articles along the first tier and route the flat articles to the sorting stations of the first tier;
a second tier transport section including a plurality of conveyor belts and rollers, the conveyor belts adapted to transport the flat articles along the second tier and rout the flat articles to the sorting stations of the second tier, the second tier transport section being disposed generally above the first tier transport section;
an elevating transport section including a plurality of conveyor belts and rollers, the elevating transport section connecting an exit end of the first tier transport section to an input end of the second tier transport section.

2. A sorting system according to claim 1, wherein the flat articles are transported on edge, in a vertical orientation between an adjacent pair of conveyor belts of the first tier transport section.

3. A sorting system according to claim 1, wherein the elevating transport section is adapted to transport flat articles that have been passed through the first tier transport section without being deposited into a first tier sorting station up to the second tier transport section.

4. A sorting system according to claim 3 further comprising
a mechanical reject pocket located downstream of the second tier of sorting stations for accepting flat articles passing through the second tier without being deposited into a pocket of a sorting station.

5. A sorting system according to claim 1, wherein the elevating transport section transports a flat article, that has been passed through the first tier transport section without being deposited into a first tier sorting station, up to the second tier.

6. A sorting system according to claim 1, wherein a flow of articles in the second tier is parallel to and in an opposite direction to flow of articles in the first tier.

7. A method of expanding an existing sorting system comprised of an existing transport section including a plurality of conveyor belts and rollers, the conveyor belts transporting flat articles along the existing transport section and routing the flat articles to the sorting stations, comprising the steps of:
modifying a downstream end of the existing transport section to allow exit of flat articles therefrom;
installing a second tier transport section generally over the existing transport section, the second tier transport section including a plurality of sorting stations, conveyor belts and rollers, the conveyor belts transporting the flat articles along the second tier and routing the flat articles to the sorting stations of the second tier;
installing an elevating transport section connecting an exit end of the existing tier transport section to an input end of the second tier transport section, the elevating transport section comprising a plurality of conveyor belts and rollers for transporting flat articles from the existing transporting section up to the second tier transport section.

8. A method according to claim 7 further comprising
using existing computer system and software for controlling operation of the second tier transport section.

9. A method according to claim 7 further comprising
arranging the elevating transport section to elevate and reverse flow direction of the flat articles such that the flat articles are then transported through the second tier transport section in a flow direction parallel and opposite to flow direction of flat articles being transported through the existing transport system.

10. A method according to claim 7 wherein the flat articles are transported on edge, in a vertical orientation between an adjacent pair of conveyor belts.

11. A method of sorting flat articles such as envelopes in a mail distribution system, comprising the steps of:
arranging a first stage transport section generally parallel with and in a stacked relationship with a second stage transport section such that one of the stages is positioned above the other, each stage having a plurality of sorting stations;
establishing a transport path (a) through the first stage transport section and to an exit thereof, (b) from the exit of the first stage transport section to an inlet of the second stage transport section, (c) through the second stage transport section;
providing diverters in the first stage transport section and the second stage transport section adapted to deposit an article in a desired pocket of a sorting station from one of the first stage and the second stage.

12. A method of sorting flat articles such as envelopes in a mail distribution system, comprising the steps of:
transporting flat articles along a transport path (a) through a first stage transport section and to an exit thereof, (b) from the exit of the first stage transport section to an inlet of a second stage transport section, and (c) through the second stage transport section, wherein the first stage transport section is arranged generally parallel with and in a stacked relationship with a second stage transport section such that one of the stages is positioned above the other, each stage having a plurality of sorting stations;
depositing an article in a desired pocket of a select one of the sorting stations by diverting the article from the transport path as the article reaches the select one of the sorting station.

13. A method according to claim 12 wherein the step of depositing an article in a desired pocket of a select one of the sorting stations includes
electronically reading information from the article;
determining the desired pocket for the article depending on the information read;
transporting the article along the transport path;
controlling operation of the sorting station corresponding to the desired pocket to divert the article from the transport path as it reaches that sorting station and to deposit the article in the desired pocket.
